(19) United States
(12) Patent Application Publication
(10) Pub. No.: US 2026/0166487 A1
(43) Pub. Date: Jun. 18, 2026

(54) A METHOD FOR REDUCING ACCUMULATION OF FOULANTS ON REVERSE OSMOSIS MEMBRANES AND A GROUNDWATER DESALINATION SYSTEM

(71) Applicant: C2 WATER (SPV) PTY LTD, Nunawading, Victoria (AU)

(72) Inventors: Christopher BARBER, Glen Forrest (AU); Christopher DAWSON, Nunawading (AU); Matthew CURKPATRICK, Rivervale (AU)

(73) Assignee: C2 WATER (SPV) PTY LTD, Nunawading, Victoria (AU)

(21) Appl. No.: 19/124,088

(22) PCT Filed: Oct. 27, 2023
(86) PCT No.: PCT/AU2023/051087

§ 371 Date: Apr. 24, 2025

(30) Foreign Application Priority Data
Oct. 27, 2022 (AU) 2022903194

(51) Int. Cl. B01D 61/02; C02F 1/44

(52) U.S. Cl. CPC B01D 61/025; C02F 1/441

(57) ABSTRACT

The present disclosure relates to a method for reducing accumulation of foulants on reverse osmosis membranes and a groundwater desalination system. An example method comprises passing a feedstream of groundwater through a water treatment unit having a plurality of reverse osmosis membranes disposed therein at a first feed pressure, the first feed pressure being greater than an osmotic pressure of the ground water feedstream, thereby producing a flow of a permeate stream and a concentrate stream; reducing the first feed pressure to a second feed pressure being less than the osmotic pressure of the groundwater, thereby generating a forward osmosis backflow of the permeate stream through said membranes into the groundwater feedstream; filtering the resulting mixture of backflow and groundwater; and discharging the filtered mixture with the concentrate stream.

### CROSS-REFERENCE TO RELATED APPLICATIONS

The present application claims priority from Australian Provisional Patent Application No 2022903194 filed on 27 Oct. 2022, the contents of which are incorporated herein by reference in their entirety.

### TECHNICAL FIELD

The present disclosure relates to a method for reducing accumulation of foulants on reverse osmosis membranes and a groundwater desalination system.

### BACKGROUND

The following discussion of the background is intended to facilitate an understanding of this disclosure. However, it should be appreciated that the discussion is not an acknowledgement or admission that any of the material referred to was published, known or part of the common general knowledge as at the priority date of the application.

Desalination of brackish or saline water by Reverse Osmosis (RO) membrane technologies is used extensively, often in large, centralised RO treatment plants for seawater desalination near cities in coastal areas and centres of population, close to a ready source of water and also a very large water body for disposal and dispersion of residual concentrate brines left after treatment. The costs of pumping water to regional, less populated areas are high.

An alternative under-utilised water source in inland areas is brackish or saline groundwater, treated locally by RO desalination to provide a usable resource. Worldwide, groundwater is the most abundant water source on land outside of polar regions and glaciers, and brackish and saline groundwater is much more abundant than fresh groundwater and surface water.

Given the wide distribution of brackish and saline groundwater on land and its underutilisation, groundwater can be exploited for water supply from small and medium-sized distributed desalination plants as opposed to those that are centralised, given a suitable aquifer and potentially allowing a large number of potential “small” users of desalination near point-of-use of water in more regional areas away from coastal margins. However, groundwater pumping requires careful management to avoid overexploitation of the resource, as does disposal of concentrate brines following desalination treatment.

It is still possible for “distributed” RO treatment of groundwater, as described here, to produce significant volumes (e.g. MLs/day) of fresh water by combining treated water produced from a large number of production boreholes and associated RO plants distributed within an area (e.g. in a wellfield configuration). Each of the latter bores could dispose of concentrate brines locally, as described here, rather than combining groundwater feed at a single centralised plant where disposal of large volumes of concentrate brines becomes problematic. Clearly, this would require careful management of the process.

RO treatment of salty groundwater is somewhat different from RO treatment of seawater. Seawater at coastal margins is a relatively high energy environment exposed to sunlight/UV radiation, with significant concentrations of nutrients, carbon sources and biota as well as high salinity. Groundwaters in subsurface aquifers, on the other hand, are characterised by the absence of sunlight, and they are generally poor in nutrients and organic carbon, and often with lower salinity than seawater. In addition, groundwaters can be naturally anoxic, containing chemically reduced forms of soluble metal ions (Fe and Mn particularly) which form membrane foulants when exposed to air during treatment. Despite generally low energy environments, groundwaters contain significant microbiological regimes (both aerobic and anoxic), as well as unique macrobiological stygofauna in niche habitats, adapted to the subterranean conditions. Groundwater environments clearly are not sterile, and RO membranes can be fouled by microbiological activity (e.g. Fe and Mn oxyhydroxide precipitates, microbial slimes etc).

The fouling of RO membranes during RO treatment of brackish and saline groundwater can be addressed by regular membrane cleaning to remove accumulated solids. For example Clean-in-Place (CIP) pumping of cleaning fluids such as mineral acids at pH 2 to dissolve scales, alkaline (pH 9) solutions to dissolve organic solids, and sterilising solutions to remove biosolids, for example at 3-6 month intervals are often used. In addition, chemical additives, such as synthetic antiscalents can be used to reduce or avoid scale formation during the RO process. The use of occasional CIP cleaning of membranes can be problematic as acid and alkaline fluids degrade the RO membranes, and foulants which have accumulated over lengthy periods are more difficult to remove due to severe blockages of pore spaces within the semi-permeable membrane elements. In addition, use of synthetic antiscalents during groundwater treatment is undesirable as these are retained in concentrated brines and residual fluids after treatment, potentially these reject streams giving rise to environmental impacts in sensitive ecosystems.

Groundwater desalination systems may also be subject to the fouling effects of iron and manganese in anoxic groundwater which react with air and oxygen to produce oxyhydroxide precipitates which foul RO membranes. Additionally, there may be environmental impacts arising from disposal of concentrate brines.

The method and system as described herein seek to alleviate some (one or more) of the aforementioned problems, or to at least provide a useful alternative to prior techniques.

### SUMMARY

The method as described herein may be used to reduce the accumulation of scale and other foulants on reverse osmosis membranes to reduce or eliminate the need for mechanical cleaning or chemical amendment.

Some embodiments relate to a method of reducing foulants accumulated on reverse osmosis membranes, the method comprising the steps of:
a) passing a feedstream of groundwater through a water treatment unit having a plurality of reverse osmosis membrane elements disposed therein at a first feed pressure, the first feed pressure being greater than an osmotic pressure of the ground water feedstream, thereby producing a flow of a permeate stream having a lower concentration of dissolved solids than the groundwater feedstream and a concentrate stream having a higher concentration of dissolved solids than the groundwater feedstream;
b) reducing the first feed pressure to a second feed pressure less than the osmotic pressure of the groundwater feedstream, thereby generating a forward osmosis backflow of the permeate stream through said membranes into the groundwater feedstream;
c) filtering the resulting mixture of backflow and groundwater;
d) reinjecting the filtered mixture into the groundwater; and
e) repeating steps a) to d).

In one embodiment, the method further comprises the step of contacting the forward osmosis permeate stream generated in step b) with carbon dioxide at a pressure sufficient to lower the pH of the permeate stream and passing the resulting carbonated permeate stream through said reverse osmosis membranes into a continuing feed stream.

In one embodiment, the carbonated forward osmosis permeate stream is passed through the reverse osmosis membranes at a small positive pressure. In this way, the carbonate scales disposed within and attached to the reverse osmosis membranes may be dissolved, at least in part, by the carbonated forward osmosis permeate stream and accumulated foulants may be dislodged.

In one embodiment, step b) may be performed for less than 30 minutes, for less than 20 minutes, for less than 15 minutes, for less than 10 minutes, or for less than 5 minutes.

In one embodiment, step b) may be performed for a period of 5 minutes to 30 minutes, for a period of 10 minutes to 20 minutes, or for about 15 minutes.

In one embodiment, steps a) to d) of the method are repeated at regular intervals. For example, steps a) to d) may be repeated every 6 h, every 12 h, every 18 h, every 24 h, every 36 h, or every 48 h.

In one embodiment, the first feed pressure is greater than the osmotic pressure of the groundwater feedstream. Conversely, the second feed pressure is less than the osmotic pressure of the groundwater feedstream.

The first feed pressure may vary depending on the total dissolved solids (TDS) in the groundwater feedstream, the type and size of the RO membrane element, the operating conditions of the desalination system (e.g., feed flowrate (F), required permeate flowrate (P) and permeate recovery 100 P/F %) under the normal defined operational conditions specified for the configured operating system (e.g., number of RO membranes per vessel, vessels in series, and so forth, as standard procedure for an RO system).

In one embodiment, the second feed pressure may be at least 3-5 bar below the osmotic pressure of the groundwater feedstream. This pressure differential is required to allow a forward osmosis permeate backflow across each RO membrane element and to maintain a higher pressure on the feed side of the membrane than the permeate pressure head to protect the RO membrane from rupture.

Some embodiments relate to a groundwater desalination system, the system comprising:
a) a production borehole casing disposed, in use, in a production borehole or well, the production borehole casing being adapted for ingress of groundwater therein;
b) a water treatment system comprising one or more reverse osmosis units having respective reverse osmosis membranes, the water treatment system being adapted to treat a groundwater stream and thereby produce a permeate stream having a lower concentration of dissolved solids than the groundwater stream and a concentrate stream having a higher concentration of dissolved solids than the groundwater stream;
c) one or more reinjection boreholes spaced apart from the production borehole, the one or more reinjection boreholes being adapted to receive the concentrate stream produced by the water treatment system;
d) a pump for passing the groundwater stream through the water treatment unit, the pump being provided with a variable speed drive to vary a pressure of the groundwater stream between a first feed pressure and a second feed pressure, wherein the first feed pressure is greater than an osmotic pressure of the ground water by an amount sufficient to establish reverse osmosis at the reverse osmosis membranes and the second feed pressure is less than the osmotic pressure of the ground water, thereby generating a forward osmosis backflow of the permeate stream through said reverse osmosis membranes into the groundwater feedstream and dislodging foulants from said reverse osmosis membranes;
e) a filter configured to filter the dislodged foulants from the resulting mixture of backflow and groundwater; and
f) a concentrate conduit configured to transport the concentrate produced from the water treatment system to the one or more reinjection boreholes;
g) wherein the one or more reinjection boreholes are provided, respectively, with a reinjection borehole casing and a seal positionable within the reinjection borehole to limit mixing and reaction between the concentrate and oxygenated water in the reinjection borehole.

In one embodiment, the concentrate conduit is provided with a flow control valve that is adjustable to pressurise the reverse osmosis units to the first feed pressure.

In one embodiment, the system further comprises a gas contactor, wherein the gas contactor is configured to allow carbon dioxide gas at 1-2 bar to pass through a gas-permeable membrane into the permeate stream, sufficient to lower the pH of the permeate stream to a predetermined value, wherein the system is configured to pass the resulting carbonated permeate stream through the reverse osmosis membranes by forward osmosis at a small positive pressure.

In one embodiment, the concentrate conduit may be further configured to transport said filtered mixture to the one or more reinjection boreholes.

In one embodiment, the system further comprises control means to control the variable speed drive to operate the pump at the second feed pressure for short periods at regular intervals. For example, the variable speed drive may operate the pump at the second feed pressure from 5 minutes to about 30 minutes every 24 h.

In one embodiment, the production borehole casing comprises a wall with a screened portion to allow water to ingress therethrough.

In one embodiment, the production borehole casing is provided with a first sealing means for sealing against the wall of the production borehole casing and dividing the production borehole casing into an upper cased portion and a lower screened portion to allow flow of ground water through the screened portion and to avoid contact between groundwater within the screened section with water above the sealing means within the cased section of the borehole which is open to air above the water level in the borehole.

In one embodiment, the one or more reinjection boreholes are provided, respectively, with a reinjection borehole casing and a second sealing means positionable within the reinjection borehole to limit mixing and reaction between the concentrate and oxygenated water in the reinjection borehole.

In one embodiment, the first sealing means and/or the second sealing means are expandable from a state receivable within said casing to an expanded state sealed against said casing. For example, the said sealing means may comprise an inflatable packer which can be selectively inflated to seal against the wall of said casing.

In one embodiment, the water treatment system and the pump may be disposed in situ in the production borehole casing.

In an alternative embodiment, the water treatment system may be disposed above ground and the pump may be disposed in situ in the production borehole casing. For example, the pump may be a submersible pump.

### BRIEF DESCRIPTION OF DRAWINGS

Preferred embodiments will now be further described and illustrated, by way of example only, with reference to the accompanying drawings in which;

FIG. 1 is a schematic representation of a groundwater desalination system in accordance with embodiments of the disclosure;

FIG. 2 is a schematic representation of a further embodiment of the groundwater desalination system; and

FIG. 3 is a flowchart of a method of reducing foulants in accordance with embodiments of the disclosure.

### DESCRIPTION OF EMBODIMENTS

The present disclosure relates to a method for reducing accumulation of foulants on reverse osmosis membranes and a groundwater desalination system.

### General Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.).

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Reference to positional descriptions, such as lower and upper, are to be taken in context of the embodiments depicted in the figures, and are not to be taken as limiting the invention to the literal interpretation of the term but rather as would be understood by the skilled addressee.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the present disclosure, suitable methods and materials are described below. In case of conflict, the present specification, including definitions, will control. In addition, the materials, methods, and examples are illustrative only and not intended to be limiting.

The term “about” as used herein means within 5%, and more preferably within 1%, of a given value or range. For example, “about 3.7%” means from 3.5 to 3.9%, preferably from 3.66 to 3.74%. When the term “about” is associated with a range of values, e.g., “about X % to Y %”, the term “about” is intended to modify both the lower (X) and upper (Y) values of the recited range. For example, “about 20% to 40%” is equivalent to “about 20% to about 40%”.

### Specific Terms

The term ‘desalination’ is used broadly to refer to any one of several processes, such as reverse osmosis, nanofiltration and ultrafiltration, that remove dissolved inorganic salts, from saline or brackish water to produce a permeate having a much lower concentration of dissolved salts than the saline or brackish water and a concentrate having a higher concentration of dissolved salts than the saline or brackish water.

The term ‘groundwater’ refers to water located beneath the earth's surface in pore spaces and in the fractures of rock formations. Groundwater may be extracted from an aquifer which is an underground layer of water-bearing permeable rock or unconsolidated materials (e.g. gravel, sand, silt, porous rock such as sandstone or limestone or variably fractured solid rock material such as granites, basalt or metasedimentary rocks) that contain and transmit groundwater.

There is considerable variability in groundwater salinity (i.e. concentration of total dissolved salts (TDS)) between aquifers and within aquifers, both temporally and spatially, particularly where recharge is intermittent and spatially variable. Groundwater is often considered brackish where groundwater contains between 1,000 mg/L to 10,000 mg/L TDS although the definition of brackish is not precise. In comparison, fresh water contains under 1,000 mg/L TDS and seawater contains generally 30,000 mg/L to 35,000 mg/L TDS. Saline groundwater is often considered to contain between 10,000 mg/L to 50,000 mg/L TDS, whilst water with TDS much higher than this is termed hypersaline, although again the definition of this type of salinity is not precise.

The term ‘osmotic pressure’ as used herein refers to the minimum pressure that may be applied to a solvent (i.e., water) to prevent its passage through a semipermeable membrane into a solution by osmosis.

‘Reverse osmosis’ or ‘RO’ refers to a water purification process that uses a partially permeable membrane to separate ions, molecules and larger particles from brackish or saline water. An applied pressure is used to overcome osmotic pressure so that the solute is retained on the pressurized side of the membrane and the solvent (water) containing low concentrations of solute (permeate) is allowed to pass to the other side of the membrane. Reverse osmosis membranes may be made in a variety of well known configurations including, but not limited to, spiral-wound and hollow-fibre. Membranes suitable for embodiments described herein can be sourced from a variety of suppliers. Suitable membranes are to be determined for each system installation based on the specific conditions under which that installation is to operate. An example tool for determining suitable membranes for certain operating conditions is the “Hydranautics IMS-D Model” software package.

The term ‘foulant’ as used herein refers to all forms of deposits of suspended or precipitated solids on or within RO membrane surfaces derived from feed groundwater or deposits resulting from microbiological activity including, but not limited to, calcium and magnesium carbonates, silica and Fe and Mn oxyhydroxide precipitates or other scales and microbial slimes.

As used herein, the terms ‘reduce’, ‘reducing’, ‘reduction’ and other grammatical forms thereof will generally refer to the prevention of foulant accumulation, the lessening of the tendency of foulant formation to occur and/or the degree to which foulant formation occurs and/or the degree to which foulant formation may be removed (i.e. ease of de-fouling a substrate surface) and/or the frequency of de-fouling a substrate surface.

### Method and System for Reducing Accumulation of Foulants on Ro Membranes

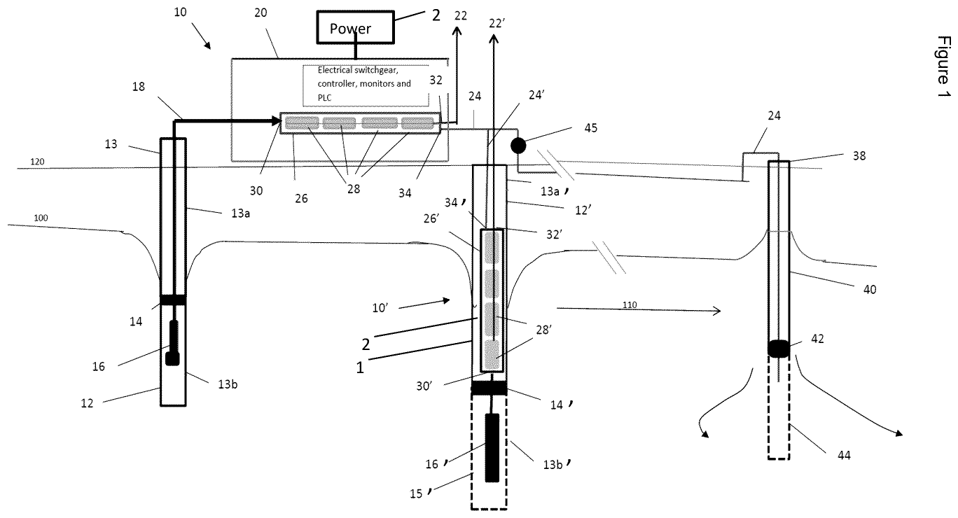

Various embodiments of a groundwater desalination system will now be disclosed with reference to FIG. 1, where like parts are referred to by like reference numbers throughout. Referring to FIG. 1, there is shown a schematic representation of an above ground desalination system 10 and a sub-surface desalination system 10′ for desalinating groundwater from an aquifer 100 having a hydraulic gradient 110 disposed beneath a ground surface 120. The above ground desalination system 10 is a system that is closed to air throughout, with its water treatment unit disposed above ground, whereas the water treatment unit of the sub-surface desalination system 10′ is disposed within the borehole (i.e., downhole), similarly closed to air, as will be described below. As shown in FIG. 1, the direction of groundwater flow is from left to right in accordance with the hydraulic gradient 110.

The above ground desalination system 10 includes a production bore hole 12 extending below the ground surface 120 and into the aquifer 100. The production bore hole 12 is lined with a casing 13 comprising an upper walled section 13a and a lower screened portion therein 13b and a seal 14 disposed between the walled upper portion 13a and the screened lower portion 13b.

The casing 13 is generally tubular and may be at least 250 mm in diameter. The casing 13 may be fabricated from impermeable materials which are preferably resistant to corrosion, more usually of rigid polymeric materials (e.g., PVC).

The screened portion 13b may take the form of a slotted casing, a perforated casing, or a mesh such as a wire wound mesh. Preferably, perforations in the screened portion are sized in the range of about 1.0 to about 0.7 mm or similar to reject sand particles. It will be appreciated that at least part of the screened portion 13b will be positioned so as to be located below the upper surface of the water table of the aquifer 100. In some embodiments, the screened portion 13b may be integrally formed with the casing 13 and fabricated from the same materials.

In some embodiments, where the aquifer 100 is relatively near the ground surface 120, the relative length of the casing 13 and the screened portion 13b may be short (e.g., about 6-12 m), whereas other deeper aquifers may require relatively long casing 13 from 20 m in length. It will be appreciated that the configuration of the production borehole and length of the screen is in most cases site specific, determined by the depth and disposition of permeable aquifer units, and required aquifer yield of groundwater for the specific desalination system (whether above ground or downhole).

The seal 14 is provided for sealing against the wall of the casing 13. Generally, the seal 14 will be disposed above the screened portion, at least in part, to allow flow of ground water through the screened portion into the lower portion 13b of the production borehole 12. In this way, the seal 14 inhibits mixing of water above and below the seal 14 within the casing 13 of the production borehole 12. The seal 14 may be positionable within the casing 13a of the production borehole 12.

The seal 14 may be fabricated from any suitable material which will enable the seal 14 to abut the wall of the casing 13 of the production borehole so as to inhibit the passage of groundwater about the seal 14. In one embodiment, the seal 14 comprises an inflatable packer which can be selectively inflated to seal the casing 13 in the production borehole 12 and subsequently deflated in order to remove or reposition the seal 14 in the casing 13 in the production borehole 12. Alternatively, the seal 14 may be fabricated from a resiliently deformable material such as a polymeric material, natural or synthetic rubber.

Groundwater flows into the production bore hole 12 through the screened portion 13b. A pump 16 is disposed within the lower screened portion 13b of the production bore hole 12 below the seal 14 to deliver a groundwater feedstream 18 via a conduit to above ground level 120. The pump 16 is in operative communication with a variable speed drive and a controller. The term “variable speed drive” as used herein refers to an electromechanical device capable of controlling the speed and torque of an AC motor by converting fixed frequency and voltage input to a variable frequency and voltage output. The term “variable speed drive” may be used interchangeably with variable-frequency drive (VFD), adjustable-frequency drive (AFD), adjustable-speed drive (ASD), ‘AC drives’, ‘micro drives’, ‘inverter drives’ and so forth. A power supply 21 is part of system 10 and provides power to the controller, the pump 16 and/or pump 16′, the various valves and actuators described herein, and any other part of system 10 requiring power.

The pump 16 may be a high pressure submersible pump capable of providing groundwater flow and sufficient pressure for operation of the desalination system 10. The depression in the water table of the aquifer 100 proximal to the production bore hole 12 is representative of the water table drawdown during pumping.

The above ground desalination system 10 also includes a ground water treatment system 20 disposed at the surface to treat the groundwater stream 18 and produce a permeate stream 22 having a lower concentration of dissolved salts than the groundwater stream and a concentrate stream 24 having a higher concentration of dissolved salts than the groundwater stream 18.

The water treatment system 20 includes a vessel 26 and one or more reverse osmosis (RO) membrane element units 28 housed therein. Generally, two or more RO membrane element units 28 may be arranged longitudinally in series in the vessel 26. The vessel 26 may be a pressure vessel, preferably designed to withstand water pressures of up to 40 bar or more. The vessel may be fabricated from fibre reinforced plastic (FRP), as used in many conventional RO desalination systems. The vessel 26 is provided with an inlet 30 to receive a groundwater stream 18, an outlet 32 for the permeate stream 22 and an outlet 34 for the concentrate stream 24.

Membranes suitable as membrane element units 28 for embodiments described herein can be sourced from a variety of suppliers. Suitable membranes are to be determined for each system 10, 20 based on the specific conditions under which that system 10, 20 is to operate. An example tool for determining suitable membranes for certain operating conditions is the “Hydranautics IMS-D Model” software package.

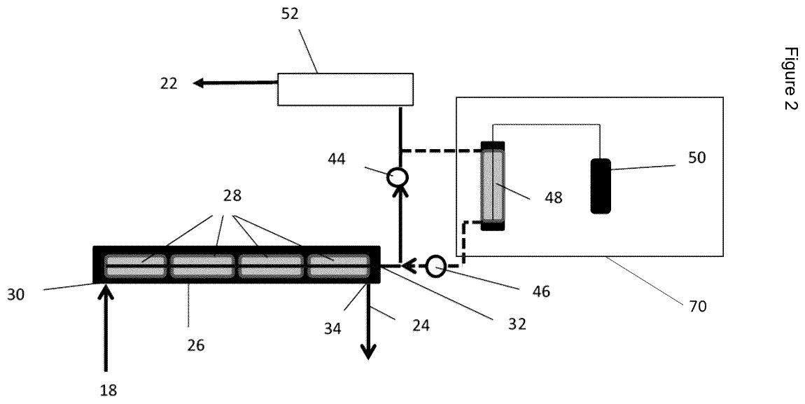

The permeate stream 22 may be directed to a small reservoir 52 (shown in FIG. 2), for example of about 100 L capacity, and thence to a larger holding tank, for example about 50,000 L capacity. Alternatively, the permeate stream 22 from the small reservoir 52 may be directed to a site pump and distribution conduit (not shown).

In use, the variable speed drive operates the pump 16 to decrease feed flows and the flow control valve 45 reduces the pressure of the groundwater stream from a first feed pressure to a second feed pressure.

The first feed pressure is greater than the osmotic pressure of the groundwater so as to establish reverse osmosis of the groundwater at the reverse osmosis membranes of said units 28 and thereby produce the permeate stream 22 and the concentrate stream 24.

The second feed pressure is below the osmotic pressure of groundwater and promotes a relatively small FO backflow. The feed flow at the second feed pressure is required to be sufficient to allow flushing of foulants from the membrane elements, and to maintain the second feed pressure well above any permeate backpressure, to avoid membrane rupture.

It will be appreciated that the osmotic pressure of the groundwater may vary depending on the concentration of TDS in the groundwater. The operating pressure for RO will be determined by the salinity and the type of RO membrane and their operational constraints and the desired optimal required treatment outcomes (feed flowrate, permeate flowrate and recovery as described above). Typically, brackish groundwaters of TDS around 2-3000 mg/L would require operating pressures of up to 10 bar, whilst more saline groundwater with TDS around 15,000 mg/L would require pressures up to 20 bar or more for 4×8 inch RO element systems.

The second feed pressure is less than the osmotic pressure of the groundwater. When the pump 16 decreases the pressure of the groundwater stream 18 to the second feed pressure, reverse osmosis ceases and forward osmosis is established, causing a backflow of the permeate stream through the reverse osmosis membranes into the groundwater feedstream which continues at a lower rate than during RO operation. The backflow of the permeate stream is relatively small at 2 to 3% of the groundwater feed stream during Forward Osmosis, sufficient to loosen and/or remove scale and biofilm from the RO membranes. In one embodiment, the second feed pressure may be no less than 5 bar for brackish groundwater and not less than 10 bar for the higher salinity groundwater using a typical 4-element RO system as described above.

In some embodiments, the back flow of the permeate stream may be drawn from the small reservoir 52 as described above and pumped at a desired rate (e.g. 2-3 L/minute). The small reservoir 52 during RO operation discharges to the larger permeate storage tanks or into a site distribution line, Hence, during FO backflow, the relatively small amount of permeate flowing from the small reservoir during backflow is replenished automatically by suction feed from the larger tank or the supply line. In this way, the above ground desalination system 10 remains isolated from air or oxygen and there is no exposure of the permeate stream to air or oxygen, thereby minimising the potential for formation of iron or manganese oxyhydroxides during FO backflow.

The backflow of the permeate stream may mix with groundwater flowing through the vessel on the groundwater feed side of the RO membranes. The water treatment system 20 may be provided with a filter (not shown) to filter the mixture of backflow and groundwater to separate solids flushed from the RO membranes therefrom. The water treatment system 20 may be further configured so that the filtered mixture is discharged with the concentrate stream 24 to the reinjection borehole 38.

The reinjection borehole 38 is disposed downstream with respect to the production borehole 12 and the direction of groundwater flow, although it will be appreciated that more than one reinjection boreholes 38 may be disposed downstream. Generally, the reinjection borehole 38 will be located at least 50 m to 100 m from the production borehole 12. The cone of impression in the water table of the aquifer 100 proximal to the reinjection borehole 38 shown in FIG. 1 is representative of localised increase in the water table due to reinjection of the concentrate stream 24. It will be appreciated that the concentrate stream 24 is denser than the groundwater and will tend to demonstrate vertical flow in a generally downward direction as indicated by the arrows in FIG. 1.

The reinjection borehole 38 is provided with a casing 40, a seal 42 for sealing against the wall of the casing 38 to limit air or oxygen ingress into the reinjection borehole 38, and a screened portion 44 to allow egress of concentrate into the reinjection borehole 38.

The seal 42 may be positionable within the casing 40 above the screened portion 44 to prevent mixing and reaction between the concentrate and oxygenated water in the reinjection borehole 38 above the screened portion 44.

It is desirable to limit introduction of air or oxygen into the reinjection borehole 38 to reduce the likelihood of undesirable chemical reactions between chemically-reduced iron and manganese ions in the concentrate and dissolved oxygen, which would result in formation of suspended flocs of iron and manganese oxyhydroxides. Such materials have the potential to clog the RO membranes and/or the aquifer media in the reinjection borehole 38.

The seal 42 may be formed of any suitable material which will enable the seal 42 to abut the wall of the casing 40 in the reinjection borehole 38 so as to inhibit the passage of water about the seal 42. In one embodiment, the seal 42 may take the form of an inflatable packer which can be selectively inflated to seal the casing 40 and subsequently deflated in order to remove or reposition the seal 42 in the casing 40 of the reinjection borehole 38. Alternatively, the seal 42 may be formed from a resiliently deformable material such as a polymeric material, natural or synthetic rubber.

The seal 42 may be provided with an aperture (not shown) to receive the conduit carrying the concentrate stream 24. Consequently, the concentrate stream 24 may be passed through the conduit and reinjected into the casing 40 of the reinjection borehole 38 below the seal 42.

In an alternative embodiment, FIG. 1 shows the sub-surface desalination system 10′ disposed in a production borehole 12 extending below the ground surface 120 and into the aquifer 100. The production bore hole 12 is lined with a casing 13 comprising a wall having a screened portion 15 therein and a seal 14 to divide the casing 13 into an upper portion and 13a a lower portion 13b.

The casing 13 is generally tubular and may be at least 250 mm in diameter. The casing 13 may be fabricated from impermeable materials which are preferably resistant to corrosion, usually of rigid polymeric materials (e.g., PVC).

The screened portion 15 may take the form of a slotted casing, a perforated casing, or a mesh such as a wire wound mesh. Preferably, perforations in the screened portion are sized in the range of about 1.0 to about 0.7 mm or similar to reject sand particles and provide at least about 80% efficiency. It will be appreciated that at least part of the screened portion 15 of the casing 13 will be positioned so as to be located below the upper surface of the water table of the aquifer 100. In some embodiments, the screened portion 15 may be integrally formed with the casing 13 and fabricated from the same materials.

In some embodiments, where the aquifer 100 is relatively near the ground surface 120, the relative length of the casing 13 and the screened portion 15 may be short (e.g., about 6-12 m), whereas in other locations the hydrology and terrain may require relatively long casing 13 from 12 m to about 20 m in length. It will be appreciated that the casing and screen lengths may vary and will be site-specific depending on local site conditions.

The seal 14 is provided for sealing against the wall of the casing 13. Generally, the seal 14 will be disposed above the screened portion 15, at least in part, to allow flow of ground water through the screened portion 15 into the lower portion 13b of the production borehole 12. In this way, the seal 14 inhibits mixing of water above and below the seal 14 within the casing 13 of the production borehole 12. The seal 14 may be positionable within the casing 13 of the production borehole 12.

The seal 14 may be fabricated from any suitable material which will enable the seal 14 to abut the wall of the casing 13 of the production borehole so as to inhibit the passage of groundwater about the seal 14. In one embodiment, the seal 14 comprises an inflatable packer which can be selectively inflated to seal the casing 13 in the production borehole 12 and subsequently deflated in order to remove or reposition the seal 14 in the casing 13 in the production borehole 12. Alternatively, the seal 14 may be fabricated from a resiliently deformable material such as a polymeric material, natural or synthetic rubber.

The sub-surface desalination system 10′ also includes a water treatment system 20′ disposed in situ in the casing 13′ of the production borehole 12′. The water treatment system 20′ is adapted to treat groundwater received in the casing 13′ and thereby produce a permeate and a concentrate as previously described.

The water treatment system 20′ includes a vessel 26′ and one or more RO membrane units 28′ housed therein. Generally, two or more RO membrane units 28′ may be arranged longitudinally in series in the vessel 26′. The vessel 26′ may be a pressure vessel, preferably designed to withstand water pressures of up to 40 bar. The vessel 26′ may be fabricated from stainless steel configured for subsurface emplacement within the casing of the production borehole. The vessel 26′ is provided with an inlet 30′ to receive groundwater, an outlet 32′ for the permeate stream 22′ and an outlet 34′ for the concentrate stream 24′.

Groundwater proximal to the production bore hole 12′ flows into the casing 13′ through the screened portion 15. A pump 16′ is disposed in the lower portion 13b′ of the production bore hole 12′ below the vessel 26′ to deliver a groundwater stream to the inlet 30′ of the vessel 26′. The pump 16′ may be a high pressure submersible pump in operative communication with a variable speed drive and a controller.

In use, the variable speed drive operates the pump 16′, which together with an adjustable flow control valve 45 varies feed flows and the pressure of the groundwater stream at a desired first feed pressure, and the variable speed drive is used to reduce the feed flows and pressure to a second feed pressure as previously described to allow a short FO backwash. Alternatively, the adjustable flow control valve 45 can be used alone to cycle between the first and second feed pressures, if suitably configured.

The first feed pressure is greater than the osmotic pressure of the groundwater so as to establish reverse osmosis of the groundwater at the reverse osmosis membranes of said units 28′ and thereby produce the permeate stream 22′ and the concentrate stream 24′. Typically, brackish groundwaters of TDS around 2-3000 mg/L would require operating pressures of up to 10 bar, whilst more saline groundwater with TDS around 15,000 mg/L would require pressures up to 20 bar or more for 4×8 inch RO element systems, defined by standard software provided by manufacturers of the RO membrane elements.

The second feed pressure is less than the osmotic pressure of the groundwater. When the pump 16′ decreases the pressure of the groundwater stream to the second feed pressure, reverse osmosis ceases and forward osmosis is established, causing a backflow of the permeate stream through the reverse osmosis membranes into the groundwater feedstream which is at a reduced flow from that obtained during RO operation at the first pressure.

The water treatment system 20′ may be provided with a filter (not shown) to filter the mixture of backflow and groundwater to separate solids flushed from the RO membranes therefrom. The water treatment system 20′ may be further configured so that the filtered mixture is discharged with the concentrate stream 24′ to the reinjection borehole 38, as previously described.

In normal RO operations, the pump 16, 16′ continuously operates at the first feed pressure so that the water treatment system 20, 20′ continuously produces the permeate stream 22, 22′ and the concentrate stream 24, 24′. The permeate stream 22, 22′ may be directed via the small 100L capacity reservoir and overflow to storage (e.g., 50 KL tank) or for use on site. The concentrate stream 24, 24′ may be directed via a conduit to a reinjection borehole 38, as previously described.

It is envisaged, however, that normal operations may be interrupted at regular intervals to operate the pump 16, 16′ at the second feed pressure for short periods.

For example, the pump 16, 16′ may operate at the second feed pressure for less than 30 minutes, for less than 20 minutes, for less than 15 minutes, for less than 10 minutes, or for less than 5 minutes. The pump 16, 16′ may be operated at the second feed pressure for a period of 5 minutes to 30 minutes, for a period of 10 minutes to 20 minutes, or for about 15 minutes.

The pump 16, 16′ may operate at the second feed pressure every 6 h, every 12 h, every 18 h, every 24 h, every 36 h, or every 48 h. In this way, regular generation of a backflow to flush the RO membranes of the water treatment system 20 prevents scale accumulation and build-up of biofilm. Because the pump 16, 16′ only operates for short periods at the second feed pressure, there is only a minor interruption of permeate production. Advantageously, with regular flushing of the RO membranes with permeate, the useable life time of the RO membranes is extended and lengthy maintenance periods to replace fouled RO membranes are avoided. Consequently, overall long-term production of permeate is improved.

With reference to FIG. 2, the above ground desalination system 10 may be adapted to provide intermittent carbonation of the permeate stream 22 during generation of the FO backflow. It will be appreciated that the subsurface desalination system 10′ may be similarly adapted.

The desalination system 10 may include a carbonation subsystem 70 in fluid communication with the permeate stream 22 via a circuit having a first check valve 44 and a second check valve 46. The carbonation subsystem 70 includes a gas contactor 48 and a source of pressurized carbon dioxide gas 50 in fluid communication with the gas contactor 48.

During RO operation, the first check valve 44 is open and the second check valve 46 is closed so that the permeate stream 22 flows through the first check valve 44 into a small reservoir 52 of about 100 L capacity. Permeate overflow can then pass into a much larger storage tank on site (e.g. 50 KL) (not shown) or directly into a freshwater supply system (not shown). The direction of flow of permeate stream 22 during RO operation is indicated by the solid line in FIG. 2.

Prior to commencement of the FO backwash, a solenoid valve to actuate the source of pressurized carbon dioxide gas 50 is opened and carbon dioxide gas at a set pressure of 1-2 bar fills the gas contactor 48. After a short period of about one minute, the variable speed drive reduces power supplied to the submersible pump 16 so that the groundwater feedstream flows decrease and the groundwater feedstream pressure is lower than the osmotic pressure as described above and reverse osmosis ceases. At this point, the first check valve 44 closes and the second check valve 46 opens to deliver FO backwash flow through the carbonation subsystem. The direction of flow of the permeate stream 22 during FO backwash is indicated by the dashed line in FIG. 2.

The second check valve 46 delivers permeate 22 from the small reservoir 52 to the gas contactor 48 where the permeate 22 is carbonated. Carbonated permeate is then delivered through the second check valve 46 to the RO unit, initiating the FO backwash. The flow of FO backwash through the RO unit may be controlled using a dosing pump delivering permeate at a desired rate.

Although the second check valve 46 is closed during RO operation, the feed side of the gas contactor 48 remains filled with carbonated permeate and carbon dioxide gas at low pressure remains in the gas contactor and permeate side of the membrane even though the solenoid valve of the source of carbon dioxide gas is closed.

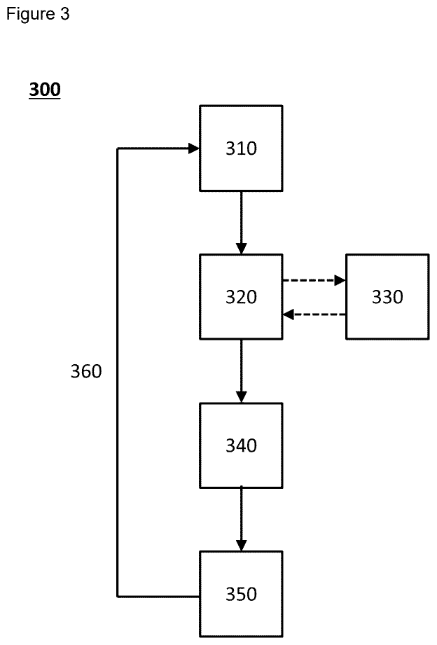

With reference to FIG. 3, a method 300 of reducing foulants is shown. The method may comprise the steps of: a) passing a feedstream of groundwater through a water treatment unit having a plurality of RO membranes disposed therein at a first feed pressure, the first feed pressure being greater than an osmotic pressure of the ground water feedstream, thereby producing a flow of a permeate stream having a lower concentration of dissolved solids than the groundwater feedstream and a concentrate stream having a higher concentration of dissolved solids than the groundwater feedstream (310); b) reducing the first feed pressure to a second feed pressure being less than the osmotic pressure of the groundwater, thereby generating a forward osmosis (FO) backflow of the permeate stream through said membranes into the groundwater feedstream (320); optionally (as indicated by the dashed lines in FIG. 3), the method may further comprise contacting the forward osmosis permeate stream generated in step b) with carbon dioxide at a pressure sufficient to lower the pH of the permeate stream and passing the resulting carbonated permeate stream through said reverse osmosis membranes into a continuing feed stream (330); c) filtering the resulting mixture of backflow and groundwater (340); d) discharging the filtered mixture with the concentrate stream (350); and, e) repeating steps a) to d) (360).

Some embodiments relate to a method of reducing foulants accumulated on a reverse osmosis membrane, the method comprising the steps of: a) passing a feedstream of groundwater through a water treatment unit comprising one or more reverse osmosis membranes at a first feed pressure, the first feed pressure being greater than an osmotic pressure of the ground water feedstream, thereby producing a permeate stream having a lower concentration of dissolved solids than the groundwater feedstream and a concentrate stream having a higher concentration of dissolved solids than the groundwater feedstream; and b) reducing the first feed pressure to a second feed pressure being less than the osmotic pressure of the groundwater, thereby generating a permeate backflow stream, at least a portion of which, passes through said membrane via forward osmosis to form a mixture with the groundwater feedstream. In other words, some embodiments do not necessarily require each of steps c), d) and e).

In some embodiments, the method optionally further comprises step c) filtering the resulting mixture of backflow and groundwater. In some embodiments, the method optionally further comprises step d) discharging the filtered mixture with the concentrate stream. In some embodiments, the method further comprises step e) repeating steps a) and b) or repeating steps a), b) and c), or repeating steps a), b) and d).

In some embodiments, the method further comprises, prior to the permeate backflow stream passing through the membrane via forward osmosis, contacting the permeate backflow stream with carbon dioxide at a pressure sufficient to lower the pH of the permeate backflow stream.

The FO backwash may operate for at least 5 minutes and up to 20 minutes or more as required depending on the extent of membrane fouling, delivering carbonated permeate at a sufficient rate to reduce the pH of feed by at least 1 pH unit, to produce significant mineral carbonate-unsaturated conditions within the RO membranes and broadly within each RO element. The specific amounts of CO₂ required and pH of permeate are determined from geochemical modelling of the permeate carbonation process eg using a suitable model such as PHREEQC (Parkhurst and Appello, 1999) as used to determine the data presented in Table 1, and from determined flowrates of carbonated permeate and feed/concentrates during set-up of the RO and FO systems.

Some typical examples of carbonation of permeate using CO₂ pressures of 2 bar, mixing of carbonated permeate and groundwater and theoretical dissolution of calcite (calcium carbonate mineral) are shown in Table 1, for three sites of differing groundwater characteristics (seawater site, a site with a high TDS of 15,000 mg/L and a less saline site with TDS of ˜8,000 mg/l). Concentrates produced using a typical RO unit (4×8 ins membrane elements operated at the first pressure and producing a permeate with recovery of 40% from a feed groundwater of 10 KL/h) from seawater feed (site 1) typically has a calcium carbonate precipitation potential (CCPP) of 78 mg/L, Site 2 concentrates has a CCPP of 98 mg/L, and site 3 a CCPP of 6 mg/L, which indicates potential for generating 11.2 kg/day, 14.1 kg/day and 8.6 kg/day from sites 1 to 3 respectively, assuming a concentrate flowrate of 6000 L/hour (144 KL/d) used in the model. The FO backflow was set at 200 L/h in the model, and the feed flow during FO was assumed to be close to 6000 L/h. The model determines the equilibrium (ideal) pH of the mixed carbonated permeate and feed groundwater and determines the amount of calcium carbonate (as mineral calcite) dissolved by the mixed solution. The total amount of calcite produced during RO is estimated from the CCPP values above and the flow of concentrates.

It is clear from Table 1 that Site 1 (seawater) and site 2 have a significant potential for carbonate scale formation, whilst site 3 is much less disposed to scaling. At sites 1 to 3, FO osmosis backwash for 10 minutes potentially dissolves more than a kilogram of carbonate scale, approximately 12%, 8% and 30% of that which potentially could accumulate during 1 day of continuous RO operation at sites 1 to 3 respectively determined from the CCPP for concentrates at each site. Doubling the backwash time to 20 minutes would double these % removal figures, assuming all precipitation and dissolution reactions proceed to equilibrium (i.e. ideal conditions). It should be recognised that the equilibrium modelling using PHREEQC or other models provide indications of the maximum amounts of carbonate scale precipitated as mineral calcite, and may overestimate actual scale formation due to non-ideal conditions such as delayed nucleation of precipitation.

It should be noted that the FO backwash is designed primarily to release foulants from the RO membranes rather than to de-scale the membranes. Hence the use of carbonate scale dissolution is to remove at least a portion of scale accumulated over a short period (e.g., 1 day) particularly that present within and on the membranes, and aid flushing out of this and other foulants into the feed stream, which is then filtered and reinjected back into groundwater. In Table 1, the model was run for only 10 mins of backwash, and nearly 10% of scale potentially could be removed by dissolution. From experience with membrane cleaning, not all carbonate scale is within the pores of membranes or attached to the membrane surface, but loosely retained within the pores of the membrane support, and hence would be flushed from the membrane elements without dissolution during the backwash, and removed by filtration. The aim of the regular, short (daily) backwash is to avoid significant accumulations of foulants within the RO elements which become progressively harder to remove with extended time (weeks or months) between membrane cleaning events. Further, the use of the regular backwash with carbonated permeate avoids the use of chemical amendments (strong mineral acids, synthetic antiscalents, biocides etc) which have potential for damaging RO membranes and for causing environmental damage from discharges of concentrates into surface and groundwater bodies.

| | | | | | | Maximum | | Maximum | | % |
|---|---|---|---|---|---|---|---|---|---|---|
| | | | | | | CaCO3 | | scalent | | removed |
| | | | Carbonated | Concentrate | | scalent | | dissolved by | | by |
| | Feed | Permeate | permeate | CCPP | | produced/ | | 10 min. | | backwash |
| Site | pH | pH | pH | (mg/L) | | day | | backwash | | per day |
| 1 amended | 8.20 | 6.10 | 3.09 | 78 | mg/L | 11.3 | kg/d | 1.3 | kg | 12% |
| 1 unamended | | 6.10 | | 78 | mg/L | | | 0.16 | kg | 1.4% |
| 2 amended | 6.8 | 5.0 | 3.12 | 98 | mg/L | 14.1 | kg/d | 1.2 | kg | 8.5% |
| 2 unamended | | 5.0 | | 98 | mg/L | | | 0.56 | kg | 4.0% |
| 3 amended | 6.9 | 5.3 | 3.48 | 6 | mg/L | 3.6 | kg/d | 1.04 | kg | 29% |
| 3 unamended | 6.9 | 5.3 | | 6 | mg/L | | | 0.17 | kg | 4.7% |

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### REFERENCES

Parkhurst D L and Appelo C A J, 1999. User's guide to PHREEQC (v2)—a computer program for speciation, one-dimensional transport and inverse geochemical calculations. USGS Water Resource Investigation Report 99-4259.

1. A method of reducing foulants accumulated on reverse osmosis membranes, the method comprising the steps of:
a) passing a feedstream of groundwater through a water treatment unit having a plurality of reverse osmosis membranes disposed therein at a first feed pressure, the first feed pressure being greater than an osmotic pressure of the ground water feedstream, thereby producing a flow of a permeate stream having a lower concentration of dissolved solids than the groundwater feedstream and a concentrate stream having a higher concentration of dissolved solids than the groundwater feedstream;
b) reducing the first feed pressure to a second feed pressure being less than the osmotic pressure of the groundwater, thereby generating a forward osmosis backflow of the permeate stream through said membranes into the groundwater feedstream;
c) filtering the resulting mixture of backflow and groundwater;
d) discharging the filtered mixture with the concentrate stream; and,
e) repeating steps a) to d).

2. The method according to claim 1, wherein the method further comprises the step of contacting a FO permeate stream generated in step b) with carbon dioxide at a pressure sufficient to lower the pH of the permeate stream and passing the resulting carbonated permeate stream through said reverse osmosis membranes into a continuing feed stream.

3. The method according to claim 2, wherein the carbonated permeate stream is passed through the reverse osmosis membranes by forward osmosis at a small positive pressure.

4. The method according to claim 1, wherein step b) is be performed for less than 30 minutes.

5. The method according to claim 1, wherein steps a) to d) of the method are repeated at regular intervals.

6. The method according to claim 5, wherein steps a) to d) are repeated at least every 24 hours.

7. The method according to claim 1, wherein the second feed pressure is at least 3 bar below the osmotic pressure of the groundwater feedstream.

8. A groundwater desalination system, the system comprising:
a production borehole casing disposed, in use, in a production borehole or well, the production borehole casing being adapted for ingress of groundwater therein;
a water treatment system comprising one or more reverse osmosis units having respective reverse osmosis membranes, the water treatment system being adapted to treat a groundwater stream and thereby produce a permeate stream having a lower concentration of dissolved solids than the groundwater stream and a concentrate stream having a higher concentration of dissolved solids than the groundwater stream;
one or more reinjection boreholes spaced apart from the production borehole, the one or more reinjection boreholes being adapted to receive the concentrate stream produced by the water treatment system;
a pump for passing the groundwater stream through the water treatment unit, the pump being provided with a variable speed drive to vary a pressure of the groundwater stream between a first feed pressure and a second feed pressure, wherein the first feed pressure is greater than an osmotic pressure of the ground water by an amount sufficient to establish reverse osmosis at the reverse osmosis membranes and the second feed pressure is less than the osmotic pressure of the ground water, thereby generating a forward osmosis backflow of the permeate stream through said reverse osmosis membranes into the groundwater feedstream and dislodging foulants from said reverse osmosis membranes;
a filter configured to filter the dislodged foulants from the resulting mixture of backflow and groundwater; and
a concentrate conduit configured to transport the concentrate produced from the water treatment system to the one or more reinjection boreholes; wherein the one or more reinjection boreholes are provided, respectively, with a reinjection borehole casing and a seal positionable within the reinjection borehole to limit mixing and reaction between the concentrate and oxygenated water in the reinjection borehole.

9. The system according to claim 8, wherein the concentrate conduit is provided with a variable speed drive and a flow control valve that are adjustable to pressurise the reverse osmosis units to the first feed pressure, and provide the necessary feed and concentrate flows for reverse osmosis treatment.

10. The system according to claim 8, wherein the system further comprises a gas contactor charged with carbon dioxide gas at 1-2 bar, wherein the gas contactor is configured to contact the permeate stream with carbon dioxide via a gas permeable membrane at a pressure sufficient to lower the pH of the permeate stream to a required value, the system being configured to pass the resulting carbonated permeate stream through the reverse osmosis membranes by forward osmosis backflow at a small positive pressure which is significantly lower than that of the second feed pressure, to mix with feed groundwater, and partially dissolve mineral carbonate scales and dislodge foulants.

11. The system according to claim 8, wherein the concentrate conduit is further configured to transport said filtered mixture to the one or more reinjection boreholes.

12. The system according to claim 8, wherein the system further comprises control means to control the variable speed drive to operate the pump at the second feed pressure for short periods at regular intervals.

13. The system according to claim 8, wherein the production borehole casing comprises a wall with a screened portion to allow water to ingress therethrough.

14. The system according to claim 8, wherein the production borehole casing is provided with a first sealing means for sealing against the wall of the production borehole casing and dividing the production borehole casing into an upper cased portion and a lower screened portion to avoid mixing of groundwater pumped into the lower screened portion with groundwater in the upper portion of the borehole above the sealing means which is open to air within the borehole.

15. The system according to claim 8, wherein the one or more reinjection boreholes are provided, respectively, with a reinjection borehole casing and a second sealing means positionable within the reinjection borehole to limit mixing and reaction between the concentrate and oxygenated water in the reinjection borehole.

16. The system according to claim 14, wherein the first sealing means is expandable from a state receivable within said production borehole casing to an expanded state sealed against said production borehole casing.

17. The system according to claim 15, wherein the second sealing means is expandable from a state receivable within said reinjection borehole casing to an expanded state sealed against said reinjection borehole casing.

18. The system according to claim 16, wherein the first sealing means or the second sealing means comprises an inflatable packer which can be selectively inflated.

19. The system according to claim 8, wherein the water treatment system and the pump are disposed in situ in the production borehole casing.

20. The system according to claim 8, wherein the water treatment system is disposed above ground and the pump is disposed in situ in the production borehole casing.
